(19) United States
(12) Patent Application Publication
(10) Pub. No.: US 2010/0144511 A1
(43) Pub. Date: Jun. 10, 2010

(54) MICROPOROUS CERAMICS AND METHODS OF MANUFACTURE

(75) Inventors: Helen M. Chan, Bethlehem, PA (US); W. Dan Powell, Columbia, MD (US); Martin P. Harmer, Trexlertown, PA (US); Jentung Ku, Silver Spring, MD (US); Suxing Wu, Allentown, PA (US)

Correspondence Address: Saul Ewing LLP (Harrisburg);Attn: Patent Docket Clerk, Penn National Insurance Plaza, 2 North Second Street, Harrisburg, PA, 17101, US

(73) Assignee: LEHIGH UNIVERSITY, Bethlehem, PA (US)

(21) Appl. No.: 12/506,561

(22) Filed: Jul. 21, 2009

Related U.S. Application Data
(60) Provisional application No. 61/082,392, filed on Jul. 21, 2008.

(51) Int. Cl. C04B 35/10; C04B 35/48; C04B 35/505

(52) U.S. Cl. 501/134; 501/153; 501/152

(57) ABSTRACT

Inorganic microporous metal oxide materials, such as aluminum-based microporous ceramic materials, useful for loop heat pipes, insulators, thermal management devices, catalyst supports, substrates, and filters, among others. An example method of manufacture includes heating a mixture of alumina (Al₂O₃) and aluminum carbonate (Al₂(CO₃)₃) powders to a temperature of at least about 1400 degrees Celsius for a pre-selected time.

### CROSS-REFERENCE TO RELATED APPLICATIONS

This application claims the priority of U.S. provisional patent application No. 61/082,392 filed on Jul. 21, 2008, which application is incorporated herein by reference in its entirety.

### STATEMENT REGARDING FEDERALLY SPONSORED RESEARCH OR DEVELOPMENT

This invention was developed with financial support from the National Aeronautics and Space Administration (Grant Nos. NNX06AD01A and NNX07AB61A). The United States government may have certain rights to the invention.

### FIELD

This disclosure pertains to inorganic microporous metal oxide materials, and more particularly to aluminum-based microporous ceramics, and methods of manufacture thereof.

### BACKGROUND

Heretofore known inorganic porous materials and methods are limited in their ability to provide uniform, predictable porosity, especially porosity that exceeds 50% of the ceramic product volume. Additionally, the control of pore size and interconnectivity is limited by known methods. Therefore, there is a continuing and unmet need for a process that consistently and efficiently yields a ceramic product with a high degree of porosity using readily available materials. Other features and advantages will be made apparent from the present specification, the teachings of which extend to those embodiments that fall within the scope of the claims, regardless of whether they accomplish one or more of the aforementioned needs.

### SUMMARY

Provided herein is a new method, based on milling and sintering technologies, for preparing a porous ceramic product from a mixture comprising powders of alumina (Al₂O₃) and aluminum carbonate (Al₂(CO₃)₃). The manufacturing methods and processes are inexpensive and take advantage of existing commercial ball and attrition milling equipment, and they further use heating equipment widely available in ceramics manufacture for sintering and firing. The process that occurs in these novel methods results in a set of pores that have an interconnected, coral-like morphology, which could potentially lead to structurally stronger porous materials as compared to known materials made by other methods.

Further provided herein are means of controlling the degree of porosity in such ceramic products. For example, porosity may be adjusted by controlling such variables as (1) composition and particle size of the powders; (2) green density (the density of a ceramic powder compact before sintering); (3) the temperature of the heating step; (4) the pre-selected time of the heating step; (5) composition of the starting mixture, such as by adjusting weight fractions; and combinations of these factors.

The methods and materials described herein also provide simple procedures for creating porous composite ceramic products, while using starting materials of alumina (Al₂O₃) and aluminum carbonate (Al₂(CO₃)₃). For example, porous alumina products can be made having controlled and consistently high porosity, such as about 20% to about 60% porosity by volume. This level of porosity in combination with the pore size and structure is unprecedented using other processes. Furthermore, the pore structure of the ceramic product generated by the process claimed and described herein comprises interconnected pores of up to about 5 microns in size. Moreover, the release of carbon dioxide from the thermal decomposition of the aluminum carbonate during the process offsets the shrinkage of metal product that is typical during sintering.

Further provided herein are novel composite materials made by such methods, wherein the starting material mixtures may further includes other metals (e.g., metal oxides) or ceramic materials. For example, novel porous ceramic products may be formed when the method is applied to starting mixtures comprising up to about 80% of Y₂O₃, ZrO₂, or combinations thereof, the mass balance including alumina (Al₂O₃) and aluminum carbonate (Al₂(CO₃)₃).

Other features and advantages will be apparent from the following more detailed description of some example embodiments.

### DESCRIPTION OF THE DRAWINGS

FIG. 1 is a flowchart illustrating the steps of an exemplary method of manufacture in accordance with an embodiment hereof.

FIG. 2 schematically illustrates an exemplary temperature profile of the heating step of such a method of manufacture.

### DETAILED DESCRIPTION

This invention includes a new method for manufacture of a microporous ceramic product includes steps of providing a mixture comprising powders of alumina (Al₂O₃) and aluminum carbonate (Al₂(CO₃)₃); and heating the mixture to a temperature of at least about 1400 degrees Celsius for a pre-selected time to thereby form a microporous ceramic product. The pre-selected time may be at least about two hours. The method may also include a step of ball milling or attrition milling of the mixture prior to heating. The method may also include steps of drying the mixture and compacting it at about 20 MPa prior to heating. The heating step of the method may include heating the mixture from room temperature to about 500 degrees Celsius for about one hour; and thereafter heating it to about 1200 for about ten hours. The heating step is thought to create porosity in the product by decomposition of carbonate. The degree of porosity in the product may also be controlled by varying the weight fraction of the alumina (Al₂O₃) and aluminum carbonate (Al₂(CO₃)₃), the particle size of the powders, the green density, the temperature of the heating step, and the pre-selected time of the heating step, among other things. The mixture may include up to about 80-90% by weight ZrO₂, the resulting product being a composite. The mixture may also include up to about 80-90% Y₂O₃, the resulting product being a composite. The mixture may also include SiO₂ up to about 5% by weight, wherein the SiO₂ modifies the pore structure and severity of flaws caused by the ceramic process. The invention also includes products formed by the foregoing method. Such materials may have a porosity that is between about 20% and about 60% by volume. The product may have an average pore size of up to about five microns, and the pores may be interconnected.

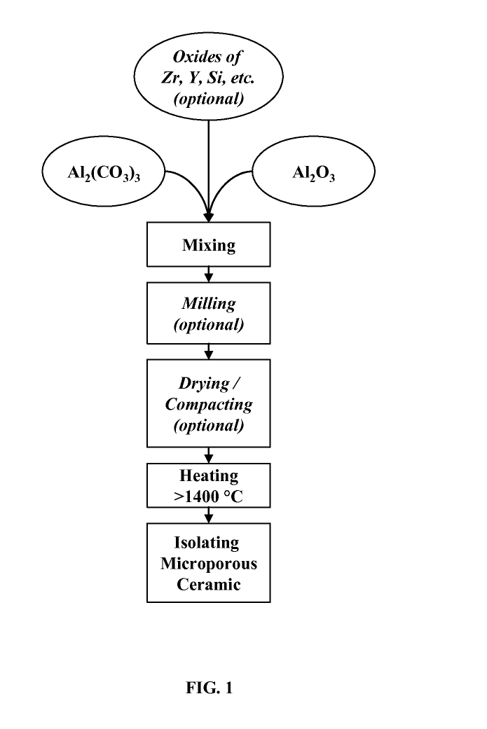

Referring to the attached drawings, FIG. 1 illustrates the steps in an exemplary method for preparing porous aluminum oxide. The method is based on the sintering process characteristic of the manufacture of ceramic objects. A starting mixture is provided comprising powders of alumina (Al₂O₃) and aluminum carbonate (Al₂(CO₃)₃), as well as other optional metal oxides.

Prior to heating, either ball milling or attrition milling may be used to provide a desired particle size range for the alumina, aluminum carbonate, or both. A purpose for the milling step is to achieve thorough mixing. Commercial milling equipment that is standard in the industry may be employed. Indeed, any particle size reduction equipment or method that yields a desired selected average particle size may be used. An exemplary selected average particle size in the starting mixture is in the range of about 0.1 micron to about 10 microns after milling. Also prior to heating, the mixture may be dried and compacted, especially if a wet milling process is used.

Next, the mixture is heated to a preselected temperature of between about 1100 and about 2000 degrees Celsius for a pre-selected time to form a porous ceramic product, which is thereafter isolated. The pre-selected time may be between about 1 to about 20 hours, for example, between about 1.5 and about 3 hours. In one embodiment, before reaching about 1400 degree Celsius, the starting mixture temperature is raised from room temperature to about 500 degrees Celsius and held at about 500 degrees Celsius for about 1 hour; and thereafter the mixture temperature is raised to about 1200 degrees Celsius for about 10 hours. For the higher temperature (e.g., 100 to about 2000 degrees Celsius), standard firing equipment and conditions can be employed. Alternatively, altered conditions such as pressure (atmospheric versus vacuum, for example) may be employed to alter the porosity density of the final product.

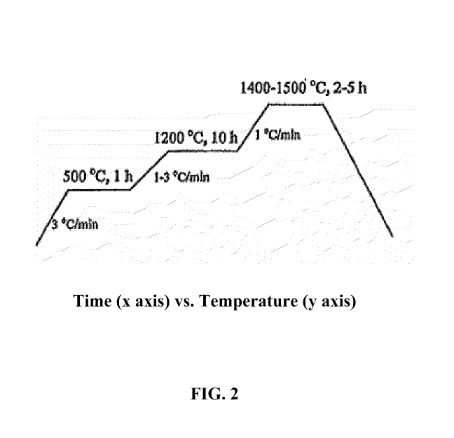

Referring to FIG. 2, an exemplary temperature/time program is illustrated. According to this temperature program, the mixture is heated at a rate of three degrees Celsius per minute from room temperature to 500 degrees Celsius, where it is maintained for one hour. Thereafter, the mixture is heated at a rate of between one to three degrees Celsius per minute to about 1200 degrees Celsius, where it is maintained for ten hours. Thereafter, the mixture is heated at a rate of one degree Celsius per minute to a final temperature of between 1400 and 1500 degrees Celsius, where it is held for between about two to five hours. Finally, the mixture is cooled to room temperature, and the resulting ceramic material is isolated.

During heating, carbon dioxide is thought to be released (by decomposition of carbonate) thereby forming pores in the material. The pore structure of the ceramic products thus made characteristically included pores of up to about ten microns in size. Most of the pores were observed to be interconnected morphology. Unlike attempts to create similarly porous ceramic products using other starting materials, the use of alumina and aluminum carbonate produced a product that had over 50% porosity by volume. Results in the range of about 20% to about 60% porosity by volume were typical.

Alternative embodiments include substituting or altering the five reaction parameters: porosity may be adjusted by controlling such variables as (1) composition and particle size of the powders; (2) green density (the density of a ceramic metal powder compact before sintering); (3) the temperature of the heating step; (4) the pre-selected time of the heating step; (5) composition of the starting mixture, such as by adjusting weight fractions; and combinations of those factors.

For example, the alumina (Al₂O₃) and aluminum carbonate (Al₂(CO₃)₃) weight fractions may be adjusted relative to one another and relative to any other ingredients in the starting mixture (such as binders, other metals, ceramics, reinforcement materials such as fibers, for example). Such adjustment of the starting materials, namely alumina (Al₂O₃) and aluminum carbonate (Al₂(CO₃)₃) yields correspondingly control of the type and extent of porosity of the final product (post-heat treatment).

Furthermore, the type and degree of porosity may be controlled by selection of the particle size of the starting mixture powders. Additionally, in yet another embodiment, the type and degree of porosity may be controlled by varying green density prior to heat treatment. Green density as used herein is understood to mean the density of a compact formed by applying pressure to the mixture while contained in a die or other known shape-forming tool, prior to a high-temperature heat treatment such as sintering or firing. Known methods, including but not limited to, application of pressure, heat, cooling, and combinations thereof, can be applied to adjust green density to a desired level.

In still other embodiments, altering variables prior to heat treatment in order to control the characteristics of the porous ceramic product involves the addition of other materials to the oxide-carbonate based mixture. For example, when SiO₂ is added to the mixture, it modifies pore structure as well as the severity of critical flaws that may otherwise occur during heat treatment or other post-heating treatment or processing. By way of further example, other embodiments of the products and methods described employ the alumina (Al₂O₃) and aluminum carbonate (Al₂(CO₃)₃) in conjunction with other metals or metal oxides to yield porous ceramic or metal-ceramic composites. For example, up to about 80-90% ZrO₂ or Y₂O₃ may be added to produce composites of alumina with those oxides. Importantly, the inventors have found that the fundamental ingredient that must be present in any embodiment is aluminum carbonate (Al₂(CO₃)₃). Experiments wherein aluminum carbonate was absent failed to produce a product having desirable porosity and other characteristics described herein for the alumina and aluminum carbonate embodiments.

Other variables that are present during the sintering itself likewise provide alternative embodiments of the porous ceramic manufacturing process. In one embodiment of the method, the degree of porosity may be controlled by varying the pre-selected time(s) of the heating step. In still another method, the degree of porosity may be controlled by varying the temperature of the heating step.

### EXAMPLES

The following example describes a porous alumina composition and its manufacturing process according to the principles of the present invention.

A powder mixture comprising 18 wt % aluminum carbonate (Alfa Aesar, stock #A12994) and 82 wt % alumina (Alfa Aesar, 99.99% purity, one micron powder, stock #39815) was attrition milled in acetone for two hours. A 50 g batch of the powder was prepared, and therefore the mixture included 9.00 g aluminum carbonate and 41.00 g alumina. After drying, the mixture was sieved through a 150 mesh sieve to improve homogeneity. Cylindrical specimens were formed by isostatic pressing in a rubber die at 30,000 psi.

The sample was heat-treated in a box furnace under an ambient atmosphere. The heat-treatment sequence was as follows: one hour at 500 degrees Celsius, followed by five hours at 1200 degrees Celsius, and then five hours at 1450 degrees Celsius. The heating rate to 500 degrees Celsius was three degrees Celsius/minute. The ramp-up rate between 500 and 1200 degrees Celsius, and between 1200 and 1450 degrees Celsius, was one degree Celsius per minute. The cooling rate from 1450 degrees Celsius was three degrees Celsius per minute.

The density of the sample was determined using the Archimedes method and was found to be 49.43% theoretic density. The average linear expansion from the pressed green body to the sintered state was measured to be 4.87%. The microstructure of the sample was characterized in the scanning electron microscope (“SEM”). It was observed to have a highly porous alumina ceramic with interconnected porosity. The grain size of the alumina was about a micron. The width of the pore channels was 0.1-1 micron. The sintered sample was sent to a commercial laboratory (Beckman Coulter, Inc., Miami, Fla.) to carry out surface area analysis by the BET method, and the surface area was determined to be 2.06 m²/g.

Although certain embodiments have been described in detail in this disclosure, those skilled in the art who review this disclosure will readily appreciate that many modifications are possible (e.g., variations in reagents, solvents, reaction times, additives, values of parameters, etc.) without materially departing from the novel teachings and advantages of the subject matter hereof. Accordingly, all such modifications are intended to be included within the scope of the present application. Furthermore, the order or sequence of any process or method steps may be varied according to alternative embodiments. Other substitutions, modifications, changes and omissions may be made in the design, operating conditions and arrangement of the exemplary embodiments without departing from the scope of the present application.

1. A method for manufacture of a microporous ceramic product comprising the steps of
providing a mixture comprising powders of alumina (Al₂O₃) and aluminum carbonate (Al₂(CO₃)₃); and
heating said mixture to a temperature of at least about 1400 degrees Celsius for a pre-selected time to thereby form a microporous ceramic product.

2. The method according to claim 1, wherein the pre-selected time is at least about two hours.

3. The method according to claim 1, further comprising the step of ball milling or attrition milling of the mixture prior to heating.

4. The method according to claim 1, wherein the method further comprises drying said mixture and compacting said mixture at about 20 MPa prior to heating.

5. The method according to claim 1, wherein said heating step comprises heating said mixture from room temperature to about 500 degrees Celsius for about one hour; and thereafter heating said mixture to about 1200 for about ten hours.

6. The method according to claim 1, wherein said heating step creates porosity in the product by decomposition of carbonate.

7. The method of claim 1, wherein the degree of porosity in the product is controlled by varying the weight fraction of the alumina (Al₂O₃) and aluminum carbonate (Al₂(CO₃)₃).

8. The method of claim 1, wherein the degree of porosity is controlled by particle size of the powders.

9. The method of claim 1, wherein the degree of porosity is controlled by varying green density.

10. The method of claim 1, wherein the degree of porosity is controlled by varying temperature of said heating step.

11. The method of claim 1, wherein the degree of porosity is controlled by varying the pre-selected time of the heating step.

12. The method of claim 1, wherein the mixture comprises up to about 80-90% by weight ZrO₂.

13. The method of claim 12, wherein the microporous product is a composite.

14. The method of claim 1, wherein the mixture comprises up to about 80-90% Y₂O₃.

15. The method of claim 14, wherein the microporous product is a composite.

16. The method of claim 1, wherein the mixture further comprises SiO₂ up to about 5% by weight.

17. The method of claim 16, wherein the SiO₂ modifies the pore structure and severity of flaws.

18. A product formed by the method of claim 1, wherein the porosity of the microporous ceramic product is between about 20% and about 60% by volume.

19. The product formed by the method of claim 1, wherein the product has an average pore size of up to about five microns.

20. The product formed by the method of claim 1, wherein the pores are interconnected.
